(19) United States
(12) Patent Application Publication
(10) Pub. No.: US 2026/0050111 A1
(43) Pub. Date: Feb. 19, 2026

(54) OPTICAL STRUCTURE AND MANUFACTURING METHOD THEREFOR

(71) Applicant: KOREA UNIVERSITY RESEARCH AND BUSINESS FOUNDATION, Seoul (KR)

(72) Inventors: Seung Woo LEE, Seoul (KR); Yong Jun LIM, Pohang-si (KR); Kwang Jin KIM, Seoul (KR); Dong Jae BAEK, Seoul (KR); Hee Ju SON, Seoul (KR)

(73) Assignee: KOREA UNIVERSITY RESEARCH AND BUSINESS FOUNDATION, Seoul (KR)

(21) Appl. No.: 19/212,101

(22) Filed: May 19, 2025

Related U.S. Application Data
(63) Continuation of application No. PCT/KR2023/018705, filed on Nov. 20, 2023.

(30) Foreign Application Priority Data
Nov. 18, 2022 (KR) 10-2022-0155206
Nov. 18, 2022 (KR) 10-2022-0155214
Jan. 26, 2023 (KR) 10-2023-0009891
Nov. 15, 2023 (KR) 10-2023-0158261

(51) Int. Cl. G02B 5/18

(52) U.S. Cl. CPC G02B 5/1857

(57) ABSTRACT

Provided is a method for manufacturing an optical structure having a difference between physical properties of a first area, which has been irradiated with light, and a second area, which has not been irradiated with light, in a photoreactive polymer composition, wherein the light with which the photoreactive polymer composition is irradiated has a sinusoidal waveform.

### TECHNICAL FIELD

The present invention relates to an optical structure which diffracts irradiated light to generate an optical signal and a method for manufacturing the same.

### BACKGROUND ART

A diffractive grating is one of the oldest optical structures. In the mid-1800s, Joseph von Fraunhofer successfully developed surface gratings, thereby opening up the world of diffraction spectrum analysis. Thereafter, in the late 1890s, Gabriel Lippman proved that a grating may be encoded in a volumetric medium, resulting in the birth of holography.

In optical structures for implementing holograms, improving the diffraction efficiency of optical structures is very important because it is directly related to the reliability of hologram implementation. Accordingly, in order to improve the diffraction efficiency of optical structures, research on photoreactive polymer compositions for forming optical structures has been actively conducted in the related art. For example, Korean Unexamined Patent Publication No. 10-2014-0059695 (May 16, 2014) discloses a technology for improving diffraction efficiency through a photoreactive polymer composition including a polymer binder, a hologram recording monomer, a photoinitiation system including at least one component of an electron acceptor, an electron donor, and a hydrogen atom donor, and a dye photosensitizer, and a solvent, in which the hologram recording monomer includes N-acryloylthiomorpholine. However, research on a technology for improving diffraction efficiency by controlling elements other than the photoreactive polymer composition (e.g., light irradiated to the photoreactive polymer composition, structural characteristics of an optical structure, etc.) is insufficient. Accordingly, the present inventors intend to propose the technology for improving diffraction efficiency by controlling elements other than the photoreactive polymer composition (e.g., light irradiated to the photoreactive polymer composition, structural characteristics of an optical structure, etc.).

### DISCLOSURE

### Technical Problem

One technical problem to be solved by the present invention is to provide an optical structure which diffracts irradiated light to generate an optical signal and a method for manufacturing the same.

Another technical problem to be solved by the present invention is to provide an optical structure with improved diffraction efficiency and a method for manufacturing the same.

Still another technical problem to be solved by the present invention is to provide an optical structure capable of improving diffraction efficiency by controlling light irradiated to a photoreactive polymer composition, and a method for manufacturing the same.

Still another technical problem to be solved by the present invention is to provide an optical structure capable of improving diffraction efficiency by controlling a thickness, and a method for manufacturing the same.

Still another technical problem to be solved by the present invention is to provide an optical structure capable of improving diffraction efficiency by controlling a refractive index modulation value, and a method for manufacturing the same.

The technical problems to be solved by the present invention are not limited to those described above.

### Technical Solution

To solve the above technical problems, the present invention provides an optical structure.

According to one embodiment, provided is a method for manufacturing an optical structure having a difference in physical properties between a first region, which is irradiated with light, and a second region, which is not irradiated with light, in a photoreactive polymer composition, in which the light irradiated to the photoreactive polymer composition may have a sinusoidal waveform.

According to one embodiment, the first region and the second region may have gradients of physical properties, respectively.

According to one embodiment, a difference in a refractive index may be formed between the first region and the second region.

According to one embodiment, the first region may have a refractive index greater than or less than a refractive index of the second region.

According to one embodiment, the light irradiated to the photoreactive polymer composition may have a single frequency.

According to one embodiment, the photoreactive polymer composition may include at least one of a polymer matrix, a monomer, and a photoinitiator.

According to one embodiment, in the photoreactive polymer composition in which the light is irradiated to the first region between the first and second regions, the monomer may be diffused from the second region to the first region.

According to one embodiment, the first region may be formed with a polymer by the monomer so that a difference in a content of the polymer may be present between the first region and the second region.

According to one embodiment, the polymer matrix may remain in the second region as the monomer is diffused from the second region to the first region, so that a difference in density may be present between the first region and the second region.

According to one embodiment, the difference in the physical properties may be present between the first region and the second region as the differences in the content and the density of the polymer may occur between the first region and the second region.

To solve the above technical problems, the present invention provides an optical structure.

According to one embodiment, in the optical structure which includes a first region and a second region having mutually different physical properties and diffracts irradiated light to generate an optical signal, diffraction efficiency of the optical structure may be controlled according to a difference in physical properties between the first region and the second region and a thickness of the optical structure.

To solve the above technical problems, the present invention provides a structure including an optical structure. According to one embodiment, in the structure including a substrate and the optical structure according to the embodiment, the first region and the second region may extend upward from a top surface of the substrate, and the thickness of the optical structure may be defined in an extension direction of the first region and the second region.

According to one embodiment, the first region may have the same physical property in a thickness direction of the optical structure, and the second region may have the same physical property in the thickness direction of the optical structure.

According to one embodiment, the difference in physical properties between the first region and the second region may include a difference in a refractive index.

### Advantageous Effects

In the optical structure according to the embodiment of the present invention, the diffraction efficiency of the optical structure may be improved by irradiating the photoreactive polymer composition with light having a sinusoidal waveform during the manufacturing process. In addition, by controlling the difference in refractive index between the first region having a relatively high refractive index and the second region having a relatively low refractive index and the thickness of the optical structure, the diffraction efficiency of the optical structure may be improved. Accordingly, since the influence of unnecessary frequency components may be minimized in generating the optical signal, only a desired optical signal may be generated.

### DESCRIPTION OF DRAWINGS

FIGS. 1 and 2 are schematic configuration views of an apparatus used in a method for manufacturing an optical structure according to an embodiment of the present invention.

FIG. 3 is a view for explaining a first region, which is irradiated with light, and a second region, which is not irradiated with light, in a photoreactive polymer composition.

FIGS. 4 and 5 are views for explaining a difference in physical properties between the first region, which is irradiated with light, and the second region, which is not irradiated with light, in the photoreactive polymer composition.

FIG. 6 is a view for explaining a difference between an optical structure formed by irradiating light having a sinusoidal waveform and an optical structure formed by irradiating light having a binary waveform.

FIG. 7 is a view for explaining a difference between an optical signal generated though the optical structure formed by irradiating light having a sinusoidal waveform and an optical signal generated through the optical structure formed by irradiating light having a binary waveform.

FIGS. 8 and 9 are views for explaining an influence of a difference in a refractive index between the first region and the second region of the optical structure on diffraction efficiency of the optical structure.

FIG. 10 is a view for explaining a difference in diffraction efficiency generated in optical structures having mutually different thicknesses.

FIG. 11 is a view comparing a diffraction efficiency full width at half maximum of a 10 μm-thick optical structure with a diffraction efficiency full width at half maximum of a 60 μm-thick optical structure.

FIG. 12 is a view for explaining a change in a path of diffracted light that moves according to a change in a thickness of the optical structure.

FIG. 13 is a view comparing diffraction efficiency of the μm-thick optical structure with diffraction efficiency of the 60 μm-thick optical structure.

FIG. 14 is a view for explaining a diffraction efficiency distribution according to a thickness of an optical structure having a refractive index modulation value (Δn_{Gp}=0.0005).

FIG. 15 is a view for explaining a diffraction efficiency distribution according to a thickness of an optical structure having a refractive index modulation value (Δn_{Gp}=0.005).

FIG. 16 is a view for explaining a diffraction efficiency distribution according to a thickness of an optical structure having a refractive index modulation value (Δn_{Gp}=0.01).

FIG. 17 is a view for explaining a relationship between the thickness of the optical structure and the refractive index modulation value.

FIG. 18 is a view illustrating structural formulae of compositions of PP used in the process of manufacturing an optical structure according to Experimental Example 1 of the present invention, and images obtained by capturing PPs that are coated with mutually different thicknesses.

FIG. 19 is a view illustrating a structural formula of PaP used in the process of manufacturing an optical structure according to Experimental Example 2 of the present invention, and images obtained by capturing PaPs that are coated with mutually different thicknesses.

FIG. 20 is a view for explaining characteristics of the optical structure according to Experimental Example 1 of the present invention.

FIG. 21 is a view for explaining characteristics of the optical structure according to Experimental Example 2 of the present invention.

### MODE FOR INVENTION

Hereinafter, preferred embodiments of the present invention will be described in detail with reference to the accompanying drawings. However, the present invention may be embodied in different forms and should not be construed as limited to the embodiments set forth herein. Rather, the embodiments are provided so that this disclosure will be thorough and complete, and will fully convey the scope of the present invention to those skilled in the art.

In the present specification, it will be understood that when an element is referred to as being “on” another element, it can be formed directly on the other element or intervening elements may be present. In the drawings, the thicknesses of layers and regions are exaggerated for clarity.

In addition, it will be also understood that although the terms first, second, third, etc. may be used herein to describe various elements, these elements should not be limited by these terms. These terms are only used to distinguish one element from another element. Thus, a first element in some embodiments may be termed a second element in other embodiments without departing from the teachings of the present invention. Embodiments explained and illustrated herein include their complementary counterparts. As used herein, the term “and/or” includes any and all combinations of one or more of the associated listed elements.

The singular expression also includes the plural meaning as long as it does not differently mean in the context. In addition, the terms “comprise”, “have” etc., of the description are used to indicate that there are features, numbers, steps, elements, or combinations thereof, and they should not exclude the possibilities of combination or addition of one or more features, numbers, operations, elements, or a combination thereof. Furthermore, it will be understood that when an element is referred to as being “connected” or “coupled” to another element, it may be directly connected or coupled to the other element or intervening elements may be present.

In addition, when detailed descriptions of related known functions or constitutions are considered to unnecessarily cloud the gist of the present invention in describing the present invention below, the detailed descriptions will not be included.

### Optical Structure According to Embodiment and Method for Manufacturing the Same

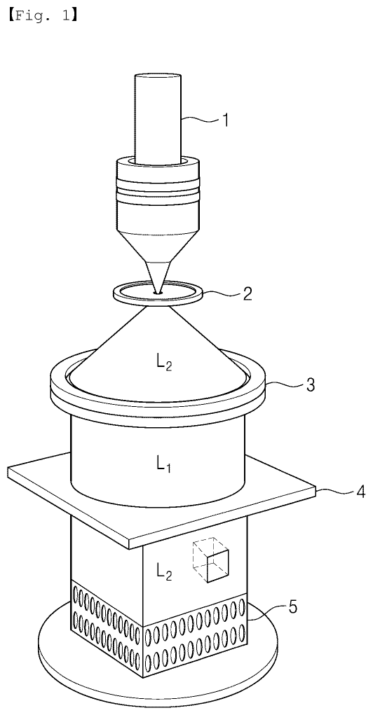

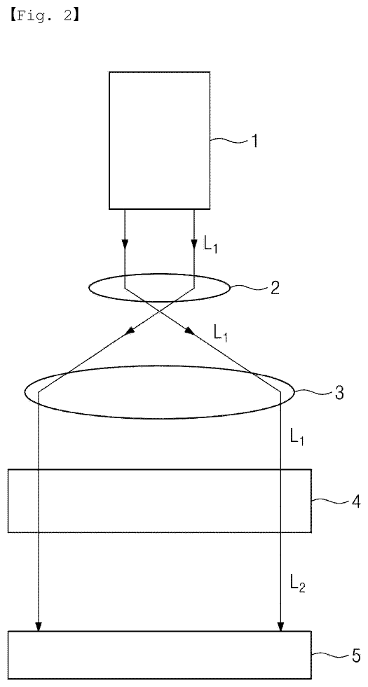

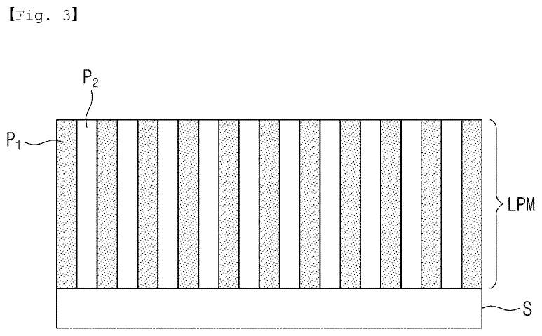

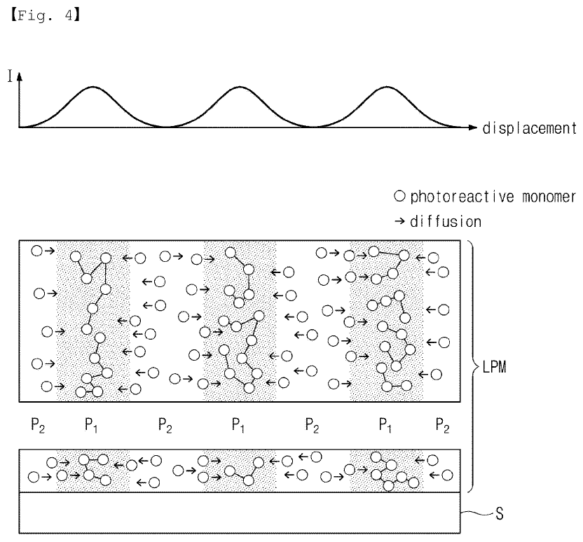

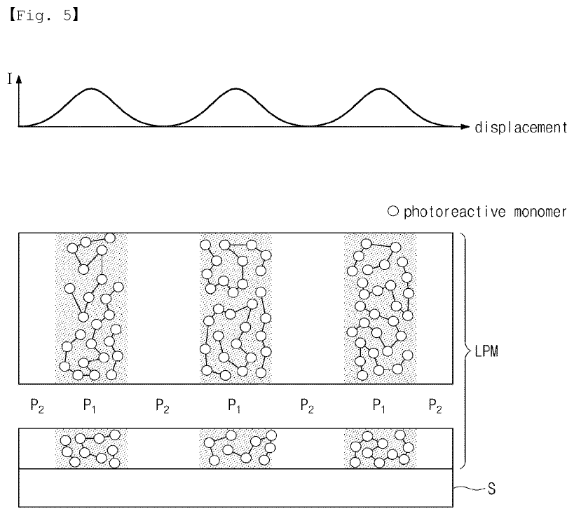

FIGS. 1 and 2 are schematic configuration views of an apparatus used in a method for manufacturing an optical structure according to an embodiment of the present invention, FIG. 3 is a view for explaining a first region, which is irradiated with light, and a second region, which is not irradiated with light, in a photoreactive polymer composition, and FIGS. 4 and 5 are views for explaining a difference in physical properties between the first region, which is irradiated with light, and the second region, which is not irradiated with light, in the photoreactive polymer composition. Referring to FIGS. 1 to 5, the apparatus for manufacturing an optical structure may include a light source 1, a first lens 2, a second lens 3, a light modulation device 4, and an optical recording medium 5. The above-described apparatus is an example of an apparatus for manufacturing an optical structure, and some of the above-described components may be omitted or other components other than the above-described components may be further included.

The light source 1 is for generating light, and according to one embodiment, the light source 1 may generate laser light that is single light.

The first lens 2 and the second lens 3 may be arranged in a direction in which light L₁ generated from the light source 1 is irradiated. The first lens 2 and the second lens 3 may transmit the light L₁ generated from the light source 1.

According to one embodiment, the light L₁ generated from the light source 1 may be transmitted through the second lens 3 after being transmitted through the first lens 2. In addition, the first lens 2 and the second lens 3 are beam expanders and may enlarge the size of the light L₁ generated from the light source 1. According to one embodiment, the first lens 2 and the second lens 3 may be omitted. However, when the first lens 2 and the second lens 3 are omitted, it may be difficult to manufacture a large-area optical structure finally generated. That is, the first lens 2 and the second lens 3 are arranged in the direction in which the light L₁ generated from the light source 1 is irradiated to enlarge a size of the light L₁ generated from the light source 1, so that it is possible to more easily manufacture the large-area optical structure finally generated.

The light L₁ transmitted through the first lens 2 and the second lens 3 may be provided to the light modulation device 4. The light L₁ provided to the light modulation device 4 may be transmitted through the light modulation device 4, and transmitted light L₂ may be modulated by the light modulation device 4. According to one embodiment, the light modulation device 4 polarizes and/or diffracts the light L₁, and examples thereof may include a photomask, a phase modulation mask, a meta-surface mask, a diffraction grating, and the like, but the present invention is not limited thereto.

The light L₂ modulated through the light modulation device 4 may be provided to the optical recording medium 5. According to one embodiment, the optical recording medium 5 may include a substrate S and a photoreactive polymer composition LPM provided on the substrate S. According to one embodiment, the photoreactive polymer composition LPM may include a polymer matrix, a monomer, and a photoinitiator.

The modulated light L₂ may be irradiated to one region of the photoreactive polymer composition LPM. A region that is irradiated with the modulated light L₂ is referred to as a first region P₁, and a region that is not irradiated with the modulated light L₂ is referred to as a second region P₂. According to one embodiment, the modulated light L₂ may be irradiated to the photoreactive polymer composition LPM such that the first region P₁ and the second region P₂ are alternately and repeatedly arranged side by side.

When the modulated light L₂ is irradiated to one region of the photoreactive polymer composition LPM, the monomers (photoreactive monomers) in the photoreactive polymer composition LPM may be diffused from the second region P₂ to the first region P₁, thereby forming a polymer by the monomers.

Accordingly, a content of the polymer may be relatively increased in the first region P₁ within the photoreactive polymer composition LPM, and thus a difference in the content of the polymer may be generated between the first region P₁ and the second region P₂. Alternatively, a polymer matrix of the photoreactive polymer composition LPM may remain in the second region P₂, and thus a difference in density of the composition may be present between the first region P₁ and the second region P₂. Accordingly, a difference in physical properties (e.g., refractive index, dielectric constant, porosity, composition, density, etc.) may be formed between the first region P₁ and the second region P₂. That is, as the differences in the content and density of the polymer occur between the first region P₁ and the second region P₂, the difference in the physical properties (e.g., refractive index, dielectric constant, porosity, composition, density, etc.) may be formed between the first region P₁ and the second region P₂. The photoreactive polymer composition LPM having a difference in the physical properties between the first region P₁, which is irradiated with light, and the second region P₂, which is not irradiated with light, may be defined as an optical structure.

The optical structure may generate an optical signal by diffracting the irradiated light. In the present invention, in order to improve diffraction efficiency of the optical structure, a waveform of the light L₂ irradiated to the photoreactive polymer composition LPM may be controlled. Specifically, the light L₂ irradiated to the photoreactive polymer composition LPM is controlled to have a sinusoidal waveform, so that the diffraction efficiency of the optical structure may be improved. In addition, according to the present invention, the diffraction efficiency of the optical structure may be improved by using a thickness of the optical structure and a difference in a refractive index between the first region P₁ and the second region P₂.

Hereinafter, an influence of the waveform of the light L₂ irradiated to the photoreactive polymer composition LPM on the diffraction efficiency of the optical structure will be described first.

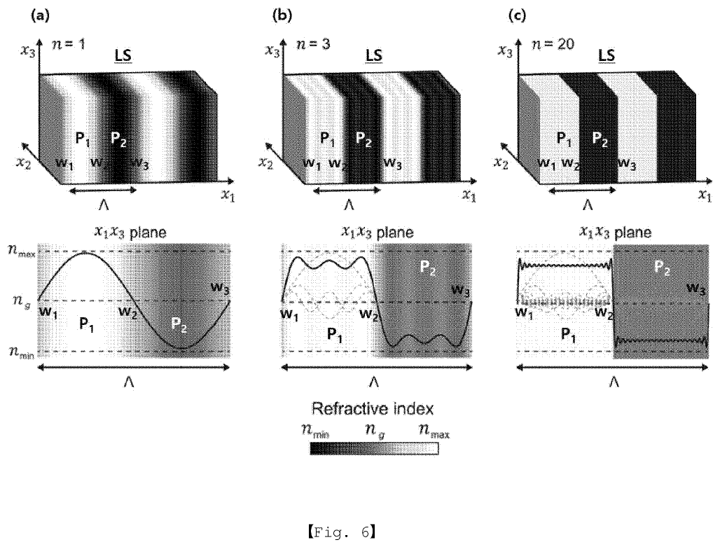

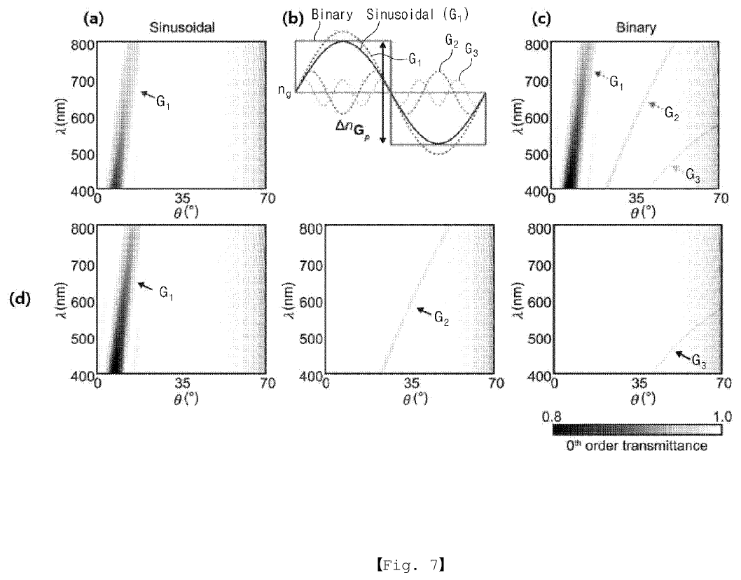

FIG. 6 is a view for explaining a difference between an optical structure formed by irradiating light having a sinusoidal waveform and an optical structure formed by irradiating light having a binary waveform, and FIG. 7 is a view for explaining a difference between an optical signal generated though the optical structure formed by irradiating light having a sinusoidal waveform and an optical signal generated through the optical structure formed by irradiating light having a binary waveform.

A binary waveform refers to a waveform in which a plurality of sinusoidal waveforms having mutually different frequencies are combined, and FIG. 6(a) illustrates an optical structure LS formed by irradiation of light having a sinusoidal waveform with a single frequency, FIG. 6(b) illustrates an optical structure LS formed by irradiation of light having a binary waveform in which three sinusoidal waveforms are combined, and FIG. 6(c) illustrates an optical structure LS formed by irradiation of light having a binary waveform in which 20 sinusoidal waveforms are combined.

FIG. 7(a) illustrates an optical signal generated by the optical structure described in FIG. 6(a), FIG. 7(c) illustrates an optical signal generated by the optical structure described in FIG. 6(b), FIG. 7(d) illustrates G₁, G₂, and G₃ illustrated in FIG. 7(c), and FIG. 7(b) illustrates a refractive index profile shown in a grating period Λ of the optical structure described in FIG. 6(a) and a refractive index profile shown in the grating period Λ of the optical structure described in FIG. 6(b).

As illustrated in FIG. 6(a), the optical structure LS formed by irradiation of light having a sinusoidal waveform with a single frequency may have a refractive index gradient in a form in which a refractive index gradually increases and decreases, and then increases again from the first region P₁ to the second region P₂ within a grating period Λ defined by the first region P₁ and the second region P₂ adjacent to each other. More specifically, the first region P₁ within the grating period Λ may have a refractive index gradient such that the refractive index gradually increases from a side wall w₁ far from the second region P₂ toward a side wall w₂ adjacent to the second region P₂ based on an effective refractive index n_{g} so as to have a maximum refractive index nₘₐₓ, and then gradually decreases to the effective refractive index n_{g}. In contrast, the second region P₂ within the grating period Λ may have a refractive index gradient such that the refractive index gradually decreases from the side wall w₂ adjacent to the first region P₁ to a side wall w₃ far from the first region P₁ so as to have a minimum refractive index nₘᵢₙ, and then gradually increases to have an effective refractive index n_{g}.

When an optical signal is generated through the optical structure having the refractive index gradient as illustrated in FIG. 6(a), as illustrated in FIGS. 7(a) and 7(b), since light diffracted through the optical structure moves through a single path G₁, optical loss may be significantly reduced, and thus the diffraction efficiency of the optical structure may be improved.

In contrast, as illustrated in FIGS. 6(b) and 6(c), the optical structure LS formed by irradiation of light having a binary waveform may have a refractive index gradient in a direction from the first region P₁ to the second region P₂ within the grating period Λ that is defined by the first region P₁ and the second region P₂ adjacent to each other, and may also have a region in which the refractive index is maintained substantially constant (a region in which an increase or decrease of the refractive index is slightly repeated). More specifically, the first region P₁ within the grating period Λ may have a refractive index gradient such that the refractive index rapidly increases from the side wall w₁ far from the second region P₂ toward the side wall w₂ adjacent to the second region P₂ based on the effective refractive index n_{g} so as to maintain the increased state, and then rapidly decreases to the effective refractive index. In contrast, the second region P₂ within the grating period Λ may have a refractive index gradient such that the refractive index rapidly decreases from the side wall w₂ adjacent to the first region P₁ to the side wall w₃ far from the first region P₁ so as to maintain the decreased state, and then rapidly increases to the effective refractive index. In particular, as illustrated in FIG. 6(c), as the binary waveform is combined with a larger number of sinusoidal waveforms, a range of a region in which the refractive index is maintained substantially constant may increase, and the deviation of the refractive index in the region in which the refractive index is maintained substantially constant may also be significantly reduced.

When an optical signal is generated through the optical structure having the refractive index gradient as illustrated in FIGS. 6(b) and 6(c), as illustrated in FIGS. 7(b) to 7(d), light diffracted through the optical structure moves through a plurality of paths G₁, G₂, and G₃, so that optical loss may occur, thereby reducing diffraction efficiency of the optical structure.

As a result, the optical structure may be manufactured by irradiating the photoreactive polymer composition LPM with light having a sinusoidal waveform, thereby improving the diffraction efficiency of the optical structure. In addition, the optical structure formed by irradiating light having a sinusoidal waveform may have a refractive index gradient in the form of a sinusoidal wave within the grating period Λ that is defined by the first region P₁ and the second region P₂ adjacent to each other. That is, the first region P₁ may have a refractive index gradient such that a refractive index of a central portion thereof is higher than a refractive index of an edge region thereof, and the second region P₂ may have a refractive index gradient such that the refractive index of the central portion thereof is lower than the refractive index of the edge region thereof. In addition, the first region P₁ may have a refractive index gradient such that the refractive index gradually increases and decreases from the side wall w₁ far from the second region P₂ toward the side wall w₂ adjacent to the second region P₂ and there is no region in which an increase or decrease in the refractive index is repeated, and the second region P₂ may have a refractive index gradient such that the refractive index gradually decreases and increases from the side wall w₂ adjacent to the first region P₁ toward the side wall w₃ far from the first region P₁ and there is no region in which the increase or decrease in the refractive index is repeated. In addition, the first region P₁ and the second region P₂ may be formed to have the same physical properties in a thickness direction of the optical structure.

The thickness direction of the optical structure may be an extension direction of the first region P₁ and the second region P₂, and the extension direction of the first region P₁ and the second region P₂ may be the same as a direction upward from a top surface of the substrate S.

Hereinabove, the influence of the waveform of light irradiated to the photoreactive polymer composition LPM on the diffraction efficiency of the optical structure has been described. Hereinafter, an influence of the thickness of the optical structure and the difference in the refractive index between the first region P₁ and the second region P₂ on the structure will be diffraction efficiency of the optical described.

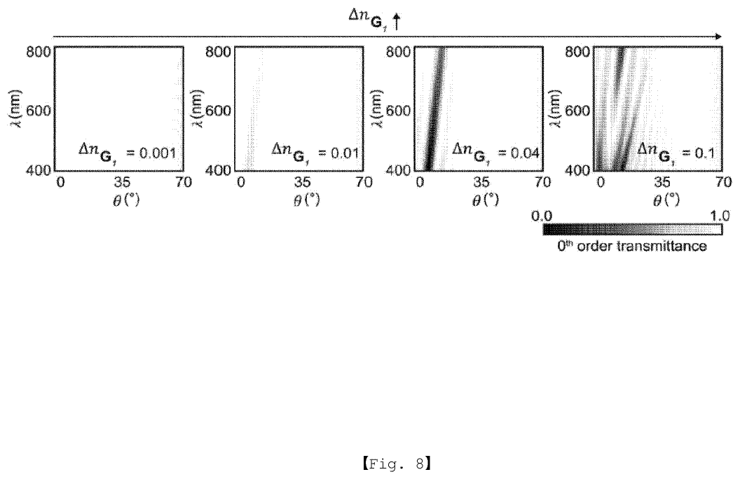

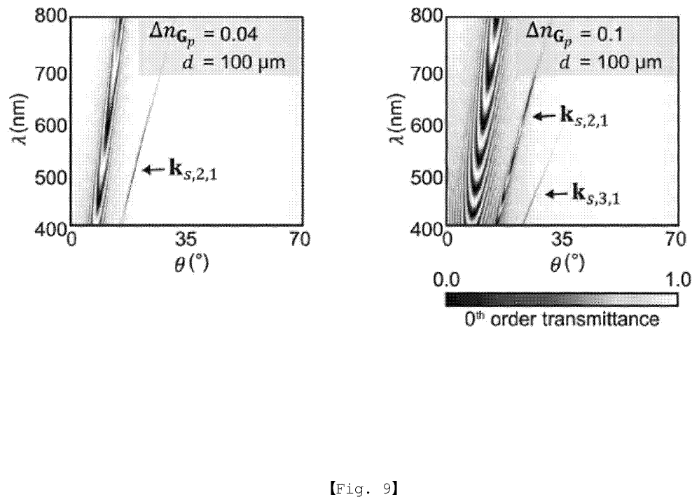

FIGS. 8 and 9 are views for explaining an influence of a difference in a refractive index between the first region and the second region of the optical structure on diffraction efficiency of the optical structure.

FIG. 8 illustrates a difference between optical signals generated according to a refractive index modulation value (Δn_{G1} or Δn_{Gp}), which is defined as a maximum value of a refractive index difference between the first region P₁ and the second region P₂, that is, a difference value between a maximum refractive index of the first region P₁ and a minimum refractive index of the second region P₂, in a state in which the thickness of the optical structure is fixed (d=100 μm), and FIG. 9 illustrates a difference between an optical signal generated at a refractive index modulation value (Δn_{Gp}=0.04) and an optical signal generated at a refractive index modulation value (Δn_{Gp}=0.1).

As can be seen from FIGS. 8 and 9, it can be seen that as the refractive index modulation value (Δn_{Gp}=0.04) increases, the number of paths through which the light diffracted through the optical structure moves significantly increases. When the number of paths through which the light diffracted through the optical structure moves increases, optical loss increases, so that the diffraction efficiency of the optical structure is reduced, and thus it can be seen that the difference in the refractive index between the first region P₁ and the second region P₂ affects the diffraction efficiency of the optical structure.

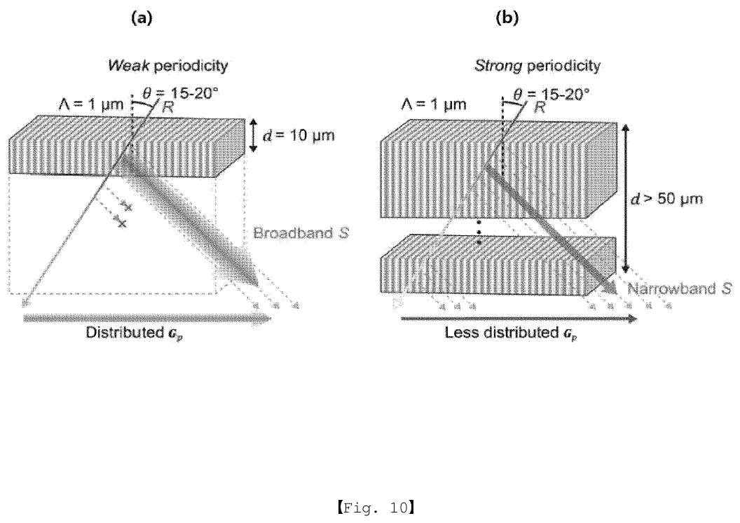

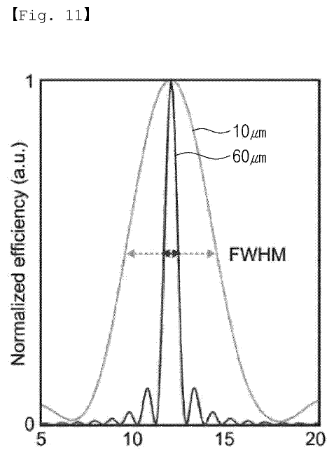

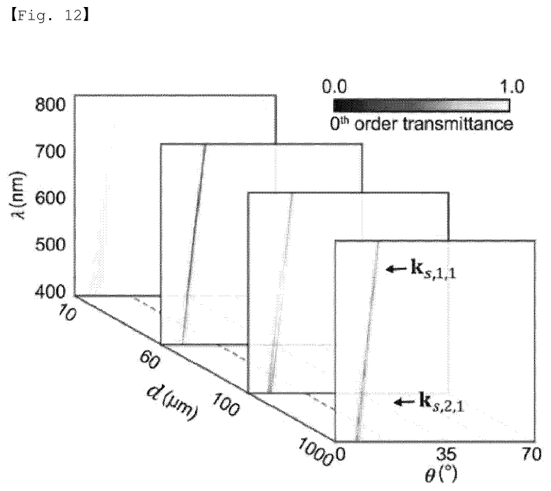

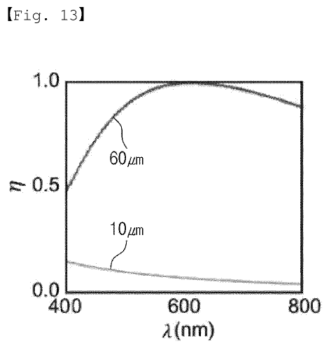

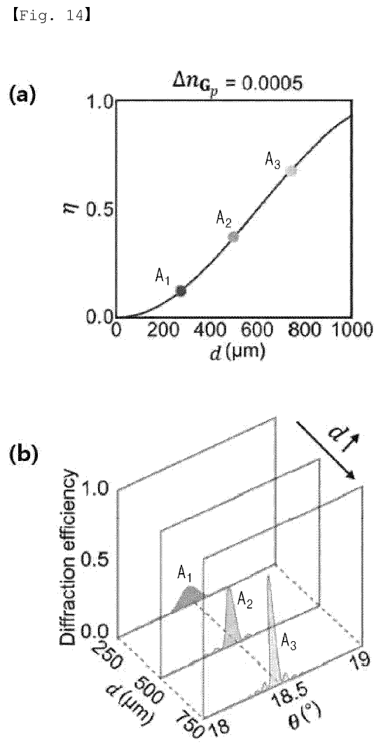

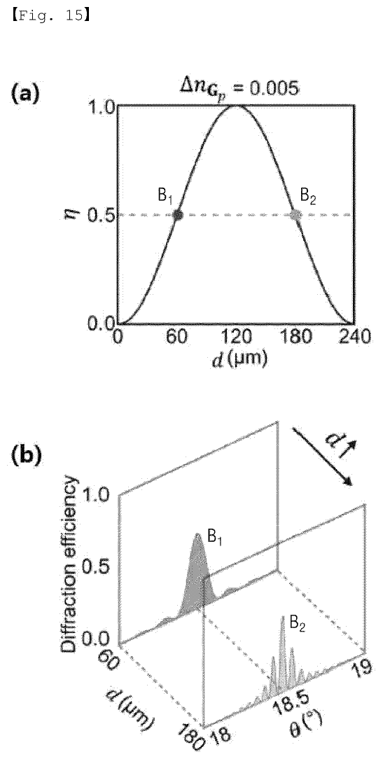

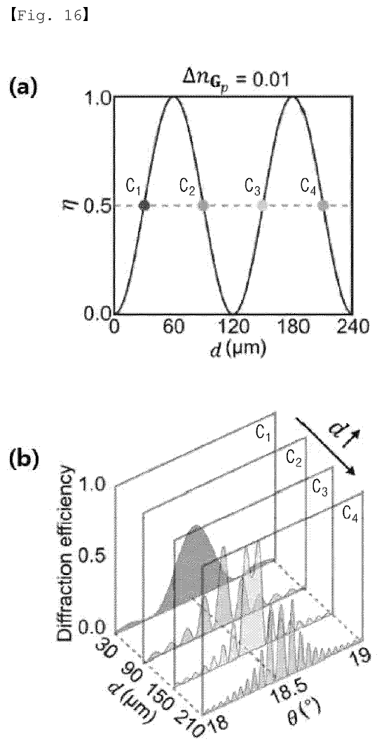

FIG. 10 is a view for explaining a difference in diffraction efficiency generated in optical structures having mutually different thicknesses, FIG. 11 is a view comparing a diffraction efficiency full width at half maximum of a 10 μm-thick optical structure with a diffraction efficiency full width at half maximum of a 60 μm-thick optical structure, FIG. 12 is a view for explaining a change in a path of diffracted light that moves according to a change in a thickness of the optical structure, FIG. 13 is a view comparing diffraction efficiency of the 10 μm-thick optical structure with diffraction efficiency of the 60 μm-thick optical structure, FIG. 14 is a view for explaining a diffraction efficiency distribution according to a thickness of an optical structure having a refractive index modulation value (Δn_{Gp}=0.0005), FIG. 15 is a view for explaining a diffraction efficiency distribution according to a thickness of an optical structure having a refractive index modulation value (Δn_{Gp}=0.005), and FIG. 16 is a view for explaining a diffraction efficiency distribution according to a thickness of an optical structure having a refractive index modulation value (Δn_{Gp}=0.01).

Referring to FIG. 10(a), an optical structure having a relatively small thickness (d=10 μm) has a weak periodicity, so that as Gₚ defined by the following <Equation 1> is dispersed, broadband diffracted light S may be formed. Accordingly, since the diffraction efficiency is limited, the diffraction efficiency may be reduced.

In contrast, referring to FIG. 10(b), an optical structure having a relatively large thickness (d>50 μm) has a strong periodicity, so that as Gₚ defined by the following <Equation 1> is less distributed, broadband diffracted light S may be formed. Accordingly, since the limitation of diffraction efficiency is eliminated, the diffraction efficiency may be improved.

$${G}_{p} = 2 π / {Λ}_{p} \qquad < Equation 1 >$$

(Λₚ: Grating period defined by first region and second region adjacent to each other)

Referring to FIG. 11, it can be seen that the diffraction efficiency full width at half maximum (FWHM) of the 10 μm-thick optical structure is significantly narrower than the diffraction efficiency FWHM of the 10 μm-thick optical structure. That is, it can be seen that the diffraction efficiency of the 10 μm-thick optical structure has a wide range, whereas the diffraction efficiency of the 60 μm-thick optical structure has a narrow range, so that the diffraction efficiency of the 60 μm-thick optical structure is improved compared to the 10 μm-thick optical structure.

Referring to FIG. 12, it can be seen that the generation of the path through which the diffracted light moves also increases as the thickness of the optical structure changes (10 μm to 1000 μm). In particular, since it is confirmed that a plurality of paths are generated at a thickness of 100 μm or greater, it can be seen that optical loss occurs at a thickness of 100 μm or greater, and thus diffraction efficiency of the optical structure is reduced.

Referring to FIG. 13, it can be seen that the diffraction efficiency n of the 60 μm-thick optical 1 structure is significantly higher than that of the 10 μm-thick optical structure.

Referring to FIGS. 14 to 16, even if the optical structures having mutually different refractive index modulation values Δn_{Gp} exhibit the same diffraction efficiency η, it can be seen that a broad optical signal is generated as the thickness increases.

That is, it can be seen from FIGS. 10 to 16 that not only the refractive index difference between the first region and the second region of the optical structure, but also the thickness of the optical structure affect the diffraction efficiency of the optical structure. Accordingly, the present invention specifically presents a method for improving the diffraction efficiency of the optical structure using the difference in the refractive index between the first region and the second region and the thickness of the optical structure.

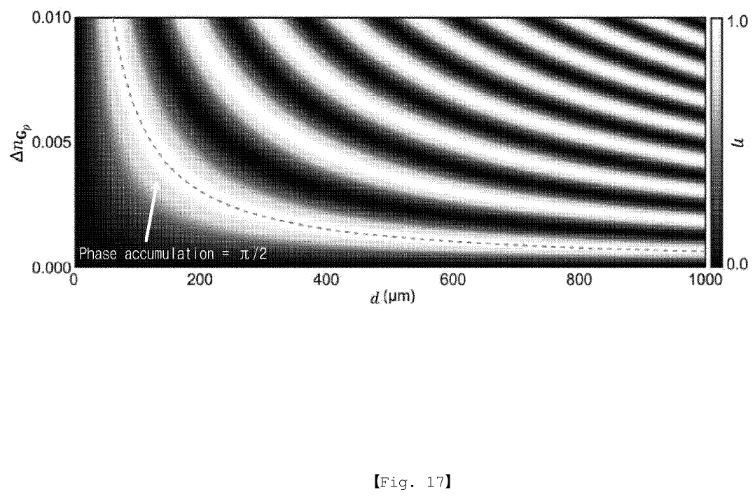

FIG. 17 is a view for explaining a relationship between the thickness of the optical structure and the refractive index modulation value.

The relationship between a thickness d of the optical structure and the refractive index modulation value Δn_{Gp} may be shown as illustrated in FIG. 17, and accordingly, a method capable of improving the diffraction efficiency of the optical structure is derived. Specifically, the diffraction efficiency of the optical structure represented by the following <Equation 3> may be derived using phase accumulation represented by the following <Equation 2>, and the diffraction efficiency may be maximized when the phase accumulation represented by <Equation 2> satisfies π/2.

$$Phase accumulaton = \frac{\frac{1}{2} Δ {n}_{{G}_{p}} d π}{λcosθ} \qquad < Equation 2 >$$

$$η = {sin}^{2} ( \frac{\frac{1}{2} Δ {n}_{{G}_{p}} d π}{λcosθ} ) \qquad < Equation 3 >$$

(η: Diffraction efficiency of optical structure, Δn_{Gp}: Refractive index modulation value defined as maximum value of difference in refractive index between first region and second region, d: Thickness of optical structure, λ: Wavelength of light irradiated to optical structure, θ: Angle between normal line of top surface of optical structure and light irradiated to optical structure)

As can be seen from <Equation 2>, when the wavelength λ of the light irradiated to the optical structure and the angle θ between the normal line of the top surface of the optical structure and the light irradiated to the optical structure are fixed, it can be seen that the phase accumulation is determined by the refractive index modulation value Δn_{Gp} and the thickness d. Accordingly, in manufacturing the optical structure, the refractive index modulation value Δn_{Gp} and the thickness d of the optical structure may be controlled so that the phase accumulation satisfies π/2, thereby maximizing the diffraction efficiency of the optical structure. In addition, since the optical structure with the maximized diffraction efficiency may minimize the influence of unnecessary frequency components in generating the optical signal, only a desired optical signal may be generated.

### Photoreactive Polymer Composition According to Embodiment

A photoreactive polymer composition according to an embodiment of the present invention may include a polymer matrix, a monomer, a photoinitiator, and a solvent. According to one embodiment, based on the total weight of the photoreactive polymer composition, the polymer matrix may be included in an amount of 20 wt %, the monomer may be included in an amount of 16 wt % or greater and 18 wt % or less, the photoinitiator may be included in an amount of 2 wt % or greater and 4 wt % or less, and the solvent may be included in an amount of 60 wt %, but the present invention is not limited to the above-described composition.

The polymer matrix may include a copolymer of a first block forming a main chain and a second block forming a side chain. According to one embodiment, the first block may include a first polymer having a relatively large molecular weight. More specifically, the first polymer may include a polymer having a degree of polymerization (DP) of less than 300. For example, the first polymer may include poly-norbornene (PNB). In contrast, the second block may include a second polymer having a relatively small molecular weight. More specifically, the second polymer may include a polymer having a DP lower than that of the first polymer. For example, the second polymer may include poly(methyl methacrylate) (PMMA). Although PNB has been exemplarily described as the first polymer and PMMA has been exemplarily described as the second polymer, various polymers in which the first block forming a main chain and the second block forming a side branch may form a copolymer may be used as the first polymer and the second polymer. That is, the type of polymer that may be used as the first polymer of the first block and the second polymer of the second block is not limited. However, unlike the above description, when a polymer having a DP of 300 or greater is used as the first polymer, there may be a problem in that a polymer film is not properly formed. In addition, when a polymer having a DP higher than the first polymer is used as the second polymer, there may be a problem in that the polymer matrix is entangled.

As described above, when the first polymer includes PNB and the second polymer includes PMMA, the polymer matrix may include a graft copolymer (PNB-g-PMMA) of PNB and PMMA, and the polymer matrix may be represented by the following <Chemical Formula 1>. In this case, the first block may be defined as a block including a compound represented by A in <Chemical Formula 1>, and the second block may be defined as a block including a compound represented by B in <Chemical Formula 2>.

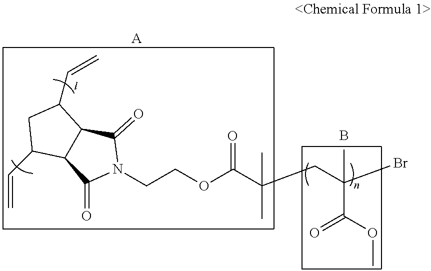

According to one embodiment, the polymer matrix may be prepared through: a step S11 of mixing a compound represented by <Chemical Formula 3> and a compound represented by <Chemical Formula 4> with tetraethylammonium (TEA) and toluene, and heat-treating the mixture at 110° C. to form a first intermediate represented by <Chemical Formula 5>; a step S12 of mixing the first intermediate and a compound represented by <Chemical Formula 6> with tetraethylammonium (TEA) and dichloromethane (DCM) at room temperature RT to form a second intermediate represented by <Chemical Formula 7>; a step S13 of mixing the second intermediate with methyl methacrylate (MMA), copper (I) bromide (Cubr), N,N,N′,N″,N″-pentamethyldiethylenetriamine (PMDETA), and anisole to form a third intermediate represented by <Chemical Formula 8>; and a step S14 of mixing the third intermediate with a G3 catalyst and dichloromethane (DCM) at room temperature RT. <Chemical Formula 3> to <Chemical Formula>8 are as follows.

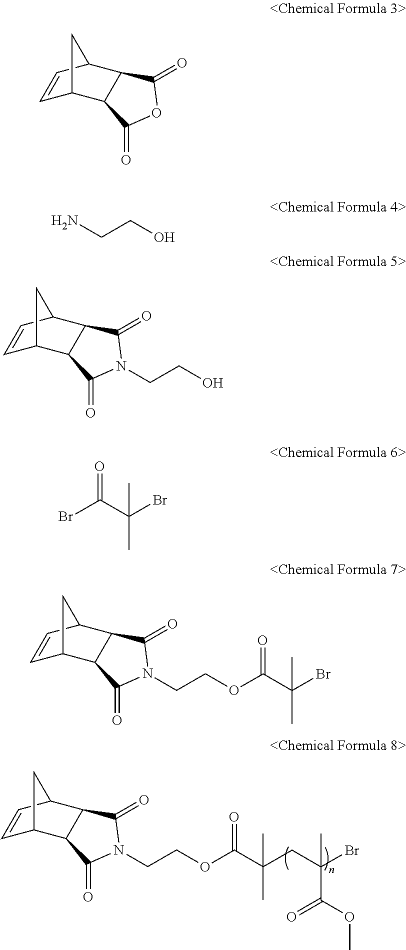

As described above, when the copolymer of the first block forming the main chain and the second block forming the side branch (e.g., PNB-g-PMMA) is used as the polymer matrix, a monomer diffusion rate of the photoreactive polymer composition may be improved compared to the case where a linear polymer (e.g., linear PMMA) is used as the polymer matrix. Accordingly, a recording speed and recording efficiency using the photoreactive polymer composition may be significantly improved.

The monomer is a material that enables radical polymerization, and in a photopolymerization process, the refractive index may be relatively increased in a region where a relatively large number of polymers are formed by the monomer, and the refractive index may be relatively decreased in a region where a relatively large number of polymer matrices are formed, thereby generating refractive index modulation and generating diffraction gratings by the refractive index modulation.

According to one embodiment, the monomer may have a refractive index of 1.4 to 1.6. In contrast, when the monomer has a refractive index other than the above-described refractive index, there is a problem in that the function as a hologram is lost because the recorded medium is not properly diffracted when a structure for the purpose of the hologram is recorded.

According to one embodiment, the monomer may include any one of acrylate and acrylamide. For example, benzyl methacrylate (BZMA) represented by <Chemical Formula 9> may be used as the monomer. In contrast, as another example, the monomer may include a (meth)acrylate-based α,β-unsaturated carboxylic acid derivative, specifically, (meth)acrylate, (meth)acrylamide, (meth)acrylonitrile, (meth)acrylic acid, or the like, or a compound including a vinyl group or a thiol group, but the present invention is not limited thereto.

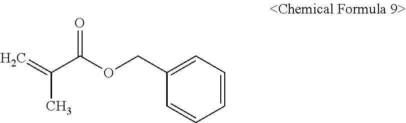

The photoinitiator is a compound activated by light, and may initiate polymerization of a compound containing a photoreactive functional group such as the monomer. According to one embodiment, the photoinitiator may include a dye, a photoinitiator, or a combination thereof, which absorbs light to generate radicals. In contrast, according to another embodiment, the photoinitiator may include a photoradical polymerization initiator. In contrast, according to still another embodiment, the photoinitiator may include a photocationic polymerization initiator or a photoanionic polymerization initiator. For example, as the photoinitiator, Irgacure represented by the following <Chemical Formula 10> may be used, and in this case, an activity reaction by light may occur as illustrated in FIG. 2. In addition, methylorange, methyleneblue, and the like may be used as the photoinitiator, but the present invention is not limited thereto.

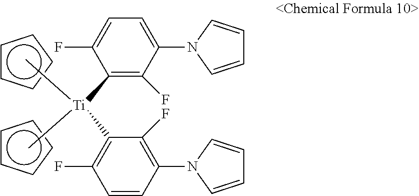

The solvent is for dispersing the above-described components (polymer matrix, monomer, and photoinitiator), and according to one embodiment, ketones, alcohols, acetates, ethers, and the like may be used. For example, as the solvent, a ketone such as methylethylketone, methylisobutylketone, acetylacetone, or isobutylketone, an alcohol such as methanol, ethanol, n-propanol, i-propanol, n-butanol, i-butanol, or t-butanol, an acetate such as ethyl acetate, i-propyl acetate, or polyethylene glycol monomethylether acetate, an ether such as tetrahydrofuran or propylene glycol monomethylether, or a mixture of two or more thereof may be used.

Hereinabove, the optical structure, the method for manufacturing the same, and the photoreactive polymer composition according to the embodiment of the present invention have been described. Hereinafter, specific exemplary examples of the optical structure, the method for manufacturing the same, and the photoreactive polymer composition according to the embodiment of the present invention will be described.

### Manufacture of Optical Structure According to Experimental Example 1

An optical structure was manufactured by using a photopolymer (PP) as a photoreactive composition and irradiating the photopolymer with light having a sinusoidal waveform. More specifically, the optical structure was manufactured through the photopolymer obtained by using poly(propylene glycol) diglycidyl ether (PPGDGE) as an epoxy matrix, pentaethylenehexamine (PHA) as a binder, benzyl methacrylate (BzMa) as a monomer, and Irgacure-784 as a photoinitiator.

### Manufacture of Optical Structure According to Experimental Example 2

An optical structure was manufactured by using a photo-addressable polymer (PaP) as a photoreactive composition and irradiating the photo-addressable polymer with light having a sinusoidal waveform. More specifically, PMMA-b-P(LC-r-AzoNO₂) was used as the photo-addressable polymer.

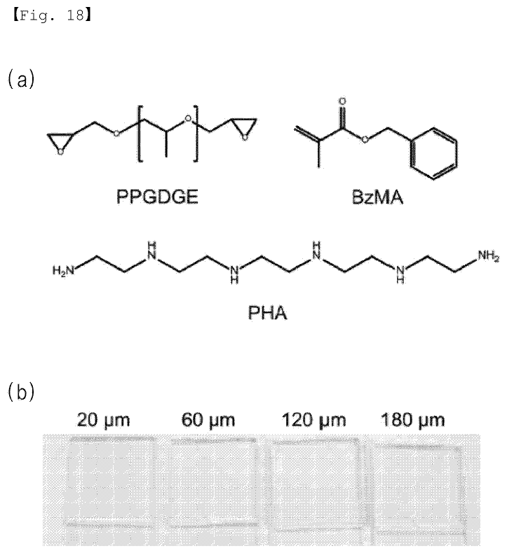

FIG. 18 is a view illustrating structural formulae of compositions of PP used in the process of manufacturing an optical structure according to Experimental Example 1 of the present invention, and images obtained by capturing PPs that are coated with mutually different thicknesses.

Referring to FIG. 18(a), structural formulae of PPGDGE, BzMa, and PHA, which are compositions of PP, can be confirmed. In addition, referring to FIG. 18(b), it can be seen that PPS are coated with mutually different thicknesses (20 μm, 60 μm, 120 μm, and 180 μm).

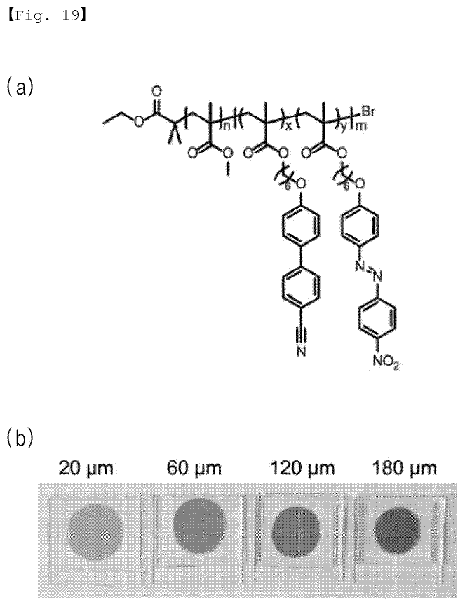

FIG. 19 is a view illustrating a structural formula of PaP used in the process of manufacturing an optical structure according to Experimental Example 2 of the present invention, and images obtained by capturing PaPs that are coated with mutually different thicknesses.

Referring to FIG. 19(a), a structural formula of PaP can be confirmed. In addition, referring to FIG. 19(b), it can be seen that PaPs are coated with mutually different thicknesses (20 μm, 60 μm, 120 μm, and 180 μm).

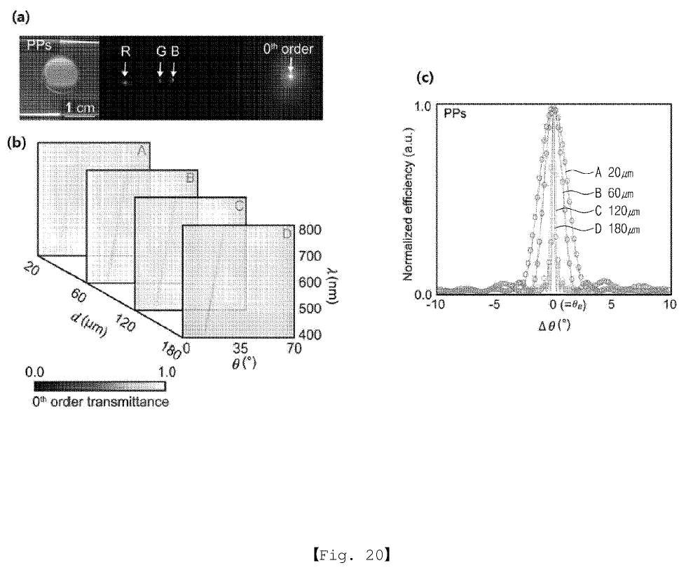

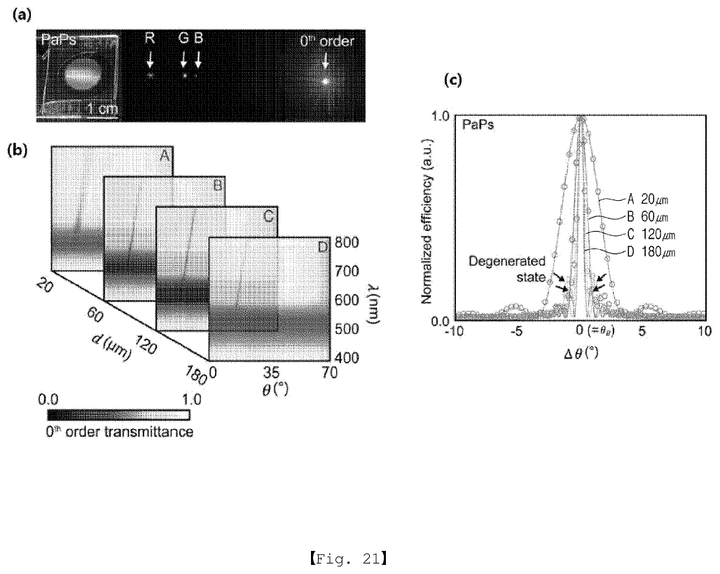

FIG. 20 is a view for explaining characteristics of the optical structure according to Experimental Example 1 of the present invention, and FIG. 21 is a view for explaining characteristics of the optical structure according to Experimental Example 2 of the present invention.

FIGS. 20(a) and 21(a) illustrate images obtained by photographing the optical structures according to Experimental Examples 1 and 2. As can be seen in FIGS. 20(a) and 21(a), it can be seen that both the optical structures according to Experimental Examples 1 and 2 exhibit strong rainbow colors under white light illumination.

FIGS. 20(b) and 21(b) illustrate dispersion diagrams of diffraction efficiency for each of the optical structures according to Experimental Examples 1 and 2, and FIGS. 20(c) and 21(c) illustrate normalized angular selectivity spectra obtained by quantifying a full width at half maximum (FWHM) at λ of 635 nm for each of the optical structures according to Experimental Examples 1 and 2.

As can be seen in FIGS. 20(b) and 21(b), it can be seen that both the optical structures according to Experimental Examples 1 and 2 have a sinusoidal refractive index modulation range. However, since the optical structure according to Experimental Example 2 has a slight high refractive index modulation value Δn_{Gp}, it can be seen that some noise appears at relatively large thicknesses (120 μm and 180 μm).

### Photoreactive Polymer Composition According to Experimental Example 3 and Manufacture of Optical Structure Using the Same

An optical structure was manufactured by preparing a photoreactive polymer composition according to Experimental Example 3 by mixing a PNB-g-PMMA polymer matrix, a BzMA monomer, an Irgacure-784 photoinitiator, and an anisole solvent, and irradiating the prepared photoreactive polymer composition with light.

The composition of the photoreactive polymer composition according to Experimental Example 3 described above was variously changed, and characteristics of the optical structure according to the changed composition were evaluated. The evaluated results are summarized in the following Table 1.

TABLE 1

| Classification | Ex 1 | Ex 2 | Ex 3 | Ex 4 | Ex 5 | Ex 6 | Ex 7 | Ex 8 |
|---|---|---|---|---|---|---|---|---|
| PNB-g-PMMA | 19 | 20 | 20 | 20 | 20 | 19 | 29 | 17 |
| (wt %) | | | | | | | | |
| BzMA (wt %) | 19 | 16 | 18 | 19.8 | 19 | 19 | 10 | 30 |
| Irgacure (wt %) | 2 | 4 | 2 | 0.2 | 1 | 2 | 1 | 3 |
| Anisole (wt %) | 60 | 60 | 60 | 60 | 60 | 60 | 60 | 60 |
| Thickness (μm) | 200 | 220 | 220 | 200 | 180 | 25 | 25 | 25 |
| Efficiency (%) | 60 | 82 | 85 | 52 | 39 | 7 | 6 | 9 |

As can be seen from <Table 1>, it can be seen that a significant difference in diffraction efficiency (Efficiency, %) is generated depending on the composition of the photoreactive polymer composition. In particular, it can be seen that high diffraction efficiency of 82% to 85% may be achieved when the composition includes a polymer matrix (PNB-g-PMMA) in an amount of 20 wt %, a monomer in an amount of 16 wt % or greater and 18 wt % or less, a photoinitiator in an amount of 2 wt % or greater and 4 wt % or less, and a solvent in an amount of 60 wt %.

While the present invention has been described in connection with the embodiments, it is not to be limited thereto but will be defined by the appended claims. In addition, it is to be understood that those skilled in the art may substitute, change, or modify the embodiments in various forms without departing from the scope and spirit of the present invention.

### INDUSTRIAL APPLICABILITY

The optical structure and the method for manufacturing the same according to the embodiment of the present application may be used in various industrial fields such as semiconductors, secondary batteries, displays, photocatalysts, hydrogen, and PUFs.

1. A method for manufacturing an optical structure having a difference in physical properties between a first region, which is irradiated with light, and a second region, which is not irradiated with light, in a photoreactive polymer composition,
wherein the light irradiated to the photoreactive polymer composition has a sinusoidal waveform.

2. The method of claim 1, wherein the first region and the second region have gradients of physical properties, respectively.

3. The method of claim 1, wherein a difference in a refractive index is formed between the first region and the second region.

4. The method of claim 3, wherein the first region has a refractive index greater than or less than a refractive index of the second region.

5. The method of claim 1, wherein the light irradiated to the photoreactive polymer composition has a single frequency.

6. The method of claim 1, wherein the photoreactive polymer composition includes at least one of a polymer matrix, a monomer, and a photoinitiator.

7. The method of claim 6, wherein in the photoreactive polymer composition in which the light is irradiated to the first region between the first and second regions, the monomer is diffused from the second region to the first region.

8. The method of claim 7, wherein the first region is formed with a polymer by the monomer so that a difference in a content of the polymer is present between the first region and the second region.

9. The method of claim 8, wherein the polymer matrix remains in the second region as the monomer is diffused from the second region to the first region, so that a difference in density is present between the first region and the second region.

10. The method of claim 9, wherein the difference in the physical properties is present between the first region and the second region as the differences in the content and the density of the polymer occur between the first region and the second region.

11. An optical structure which includes a first region and a second region having mutually different physical properties and diffracts irradiated light to generate an optical signal,
wherein diffraction efficiency of the optical structure is controlled according to a difference in physical properties between the first region and the second region and a thickness of the optical structure.

12. A structure comprising a substrate and the optical structure of claim 11 disposed on the substrate,
wherein the first region and the second region extend upward from a top surface of the substrate, and
the thickness of the optical structure is defined in an extension direction of the first region and the second region.

13. The structure of claim 12, wherein the first region has the same physical property in a thickness direction of the optical structure, and the second region has the same physical property in the thickness direction of the optical structure.

14. The structure of claim 12, wherein the difference in physical properties between the first region and the second region includes a difference in a refractive index.
